(19) United States
(12) Patent Application Publication
(10) Pub. No.: US 2013/0206304 A1
(43) Pub. Date: Aug. 15, 2013

(54) RUN FLAT TIRE INCORPORATING IDENTICAL AND BOLT INTERLOCKING HALVES WITH IMPROVED INNER RIM MOUNTING RING WITH NOTED AND OVERLAPPED CONFIGURATION AND FURTHER EXHIBITING A COMBINATION NON-SLIP AND ANTI-GALVANIC COMPOSITION IN CONTACT WITH THE RIM

(71) Applicants: Joseph G. Russell, II, Ira, MI (US); Joseph G. Russell, SR., Ira, MI (US)

(72) Inventors: Joseph G. Russell, II, Ira, MI (US); Joseph G. Russell, SR., Ira, MI (US)

(21) Appl. No.: 13/765,489

(22) Filed: Feb. 12, 2013

Related U.S. Application Data
(60) Provisional application No. 61/598,696, filed on Feb. 14, 2012.

(51) Int. Cl. B60C 17/00

(52) U.S. Cl. CPC B60C 17/009
USPC 152/516

(57) ABSTRACT

A run flat tire for use with a conventional wheel supporting an outer tire. First and second semi-circular shaped subassemblies inter-engage around an annular surface of the wheel, each of the subassemblies exhibiting an outer support ring adapted to engage a deflated inner surface of the outer tire in a run flat condition. The subassemblies exhibit stamped metal bodies and include stiffening beads for increased strength. Each of the subassemblies also includes a semi-circular shaped body cap exhibiting a flat band in end profile and which is secured to inner support locations associated with the spaced apart sides of the main body. Each of the subassemblies includes an innermost rim mounting ring secured to the wheel surface and exhibiting a cross sectional profile matching a selected wheel rim design.

### CROSS-REFERENCE TO RELATED APPLICATIONS

This Application claims the benefit of U.S. Provisional Application 61/598,696 filed on Feb. 14, 2012.

### FIELD OF THE INVENTION

The present invention discloses an identical pair of custom configured and circumferentially assembleable semi-circular body portions (or insert halves) for encircling a vehicle rim underneath a nominally inflated tire and for providing roll flat support around the wheel rim in the event of loss of pressure (typically indicative of puncture) of the surrounding tire. Additional features include the provision of an inner rim mounting ring with reinforcing joint overlap profile, combined with an inner frictional/non-slip and anti-galvanic corrosive composition. The sizing of the identical insert halves is further determined by the rim construction associated with a specified vehicle and tire size.

### BACKGROUND OF THE INVENTION

The prior art is well documented with examples of run-flat tire assemblies, these typically defining an inwardly spaced diameter support about the wheel and which provides backup protection in the event of a sudden loss of pressure of the outer tire, such resulting from a blowout resulting from natural or man-made circumstances. A first set of prior art references depicting such wheel rim attachments include each of the Lindley U.S. Pat. Nos. 3,142,326, 3,141,490, 3,135,556 and 2,986,189 patents.

Additional prior art examples include Smith, U.S. Pat. No. 4,573,509 which teaches a locking device with locking bolts established between semi-circular inserts. Bouvier, U.S. Pat. No. 6,814,114 further discloses a tire to rim rotation limiter for a run flat assembly with a variety of frictional inducing structure employed between the ends of the side walls in order to prevent relative rotational movement between the tire and rim.

### SUMMARY OF THE INVENTION

The present invention discloses a run flat tire for use with a conventional wheel supporting an outer tire. First and second semi-circular shaped subassemblies are adapted to being inter-engaged in end-to-end fashion around an annular surface of the wheel, each of the subassemblies exhibiting an outer support ring adapted to engage a deflated inner surface of the outer tire in a run flat condition.

The first and second subassemblies each exhibit a stamped metal body substantially “U” shaped in cross section and including stiffening beads for increased strength. Each of the subassemblies also includes a semi-circular shaped body cap exhibiting a flat band in end profile and which is secured to inner support locations associated with the spaced apart sides of the main body.

Each of the subassemblies further includes an innermost rim mounting ring welded or toggle locked in place in secure fashion to the annular wheel surface, the innermost rim exhibiting a customizable cross sectional profile for matching a selected wheel rim design associated with a given vehicle make or manufacture. Each of the stamped metal bodies is also constructed of an anti-galvanic material.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an environmental perspective of the wheel rim supported run flat tire;

FIG. 2 is an exploded view of FIG. 1 and further depicting an outer inflatable tire;

FIG. 3 is a further environmental perspective similar to FIG. 1 of the assembly shown in FIG. 2 and further illustrating, in partial cutaway, the outer tire in an inflated condition and in order to illustrate its spatial arrangement relative to the inner wheel rim supported run flat tire;

FIG. 4 is a side view of the wheel rim and run flat tire depicted in FIG. 1;

FIG. 5 is an end view of the wheel rim and run flat tire;

FIG. 6 is a further exploded view of a selected semi-circular subassembly providing one half of the overall assembly;

FIG. 7A is a cutaway view taken along line 7A-7A of FIG. 3 and illustrating from an end view a spatial distance between the wheel rim mounted run flat tire and an inner inflated end surface of the surrounding tire;

FIG. 7B is a succeeding view to FIG. 7A and depicting the surrounding tire in a deflated position in which the outer annular surface of the run flat tire provided run flat support to the inner wheel rim;

FIG. 8 is a plan cutaway of the environmental assembly of FIG. 3 as further illustrated by line 8-8 of FIG. 5 and better illustrating the overlapping assembled components associated with each bolt interlocking half ring defining the run flat tire;

FIG. 9A is an enlarged partial view taken from an interlocking location of the ring halves in FIG. 8 and better showing the mounting bolt and bracket interface relationship prior to being securely fastened;

FIG. 9B is a succeeding view to FIG. 9A, further referencing in enlarged partial representation the interface location in FIG. 8, and in which the half ring portions are bolted in place in securely attached fashion about the wheel rim;

FIG. 10 is an enlarged partial view of a further circumferentially offset cutaway location depicted in FIG. 8, relative to that shown in FIG. 9B, and illustrating one variant of snap-engagement of projecting portions associated with an inner annular surface of the rubberized outer tread ring in engagement with aligning recess locations defined in the supporting annular surface of the main arcuate body;

FIG. 11 is an illustration similar to that shown in FIG. 10 of an alternate attachment configuration in which an adhesive agent secures the outer tread material to the underlying main arcuate body;

FIG. 12 is a further illustration of another alternate attachment configuration depicting a series of circumferentially spaced rivets for securing the outer tread material to the underlying main arcuate body; and

FIG. 13 is a yet further illustration of another attachment configuration depicting a series of circumferentially spaced screws for securing the outer tread material to the underlying main arcuate body.

### DETAILED DESCRIPTION OF THE PREFERRED EMBODIMENTS

As previously described, the present invention discloses a run flat tire secured about an exterior perimeter of a vehicle wheel which also supports a surrounding and inflatable tire. In the instance of deflation of the outer tire, regardless of circumstance, the inner rim supported run flat tire provides backup support and which permits continued vehicle motion without damaging the wheel.

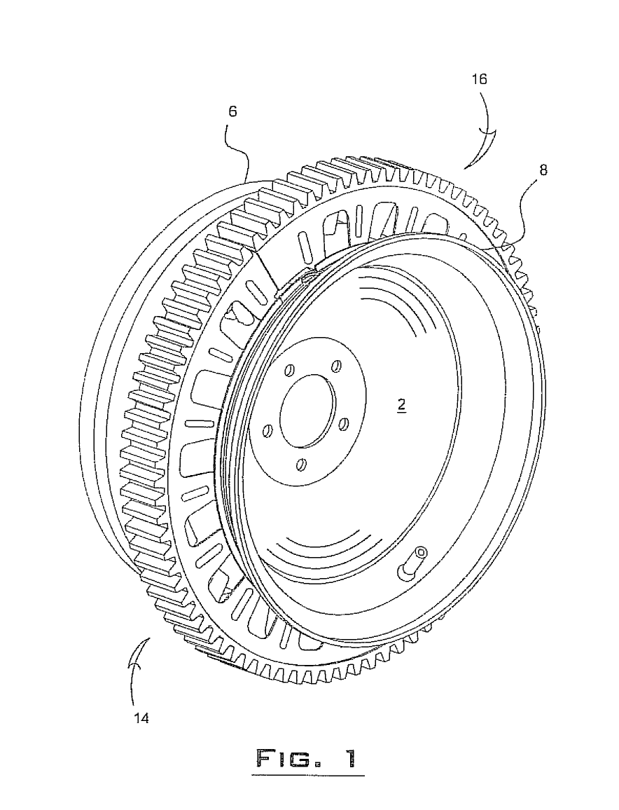

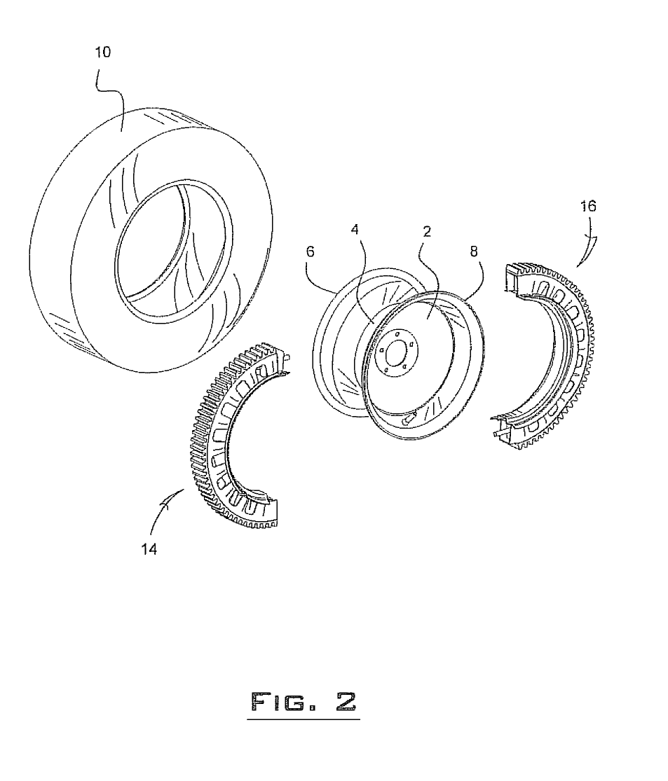

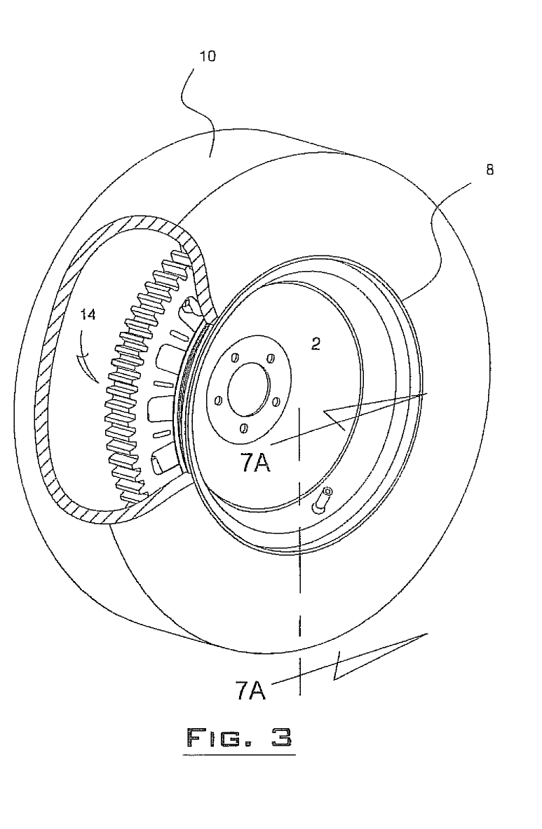

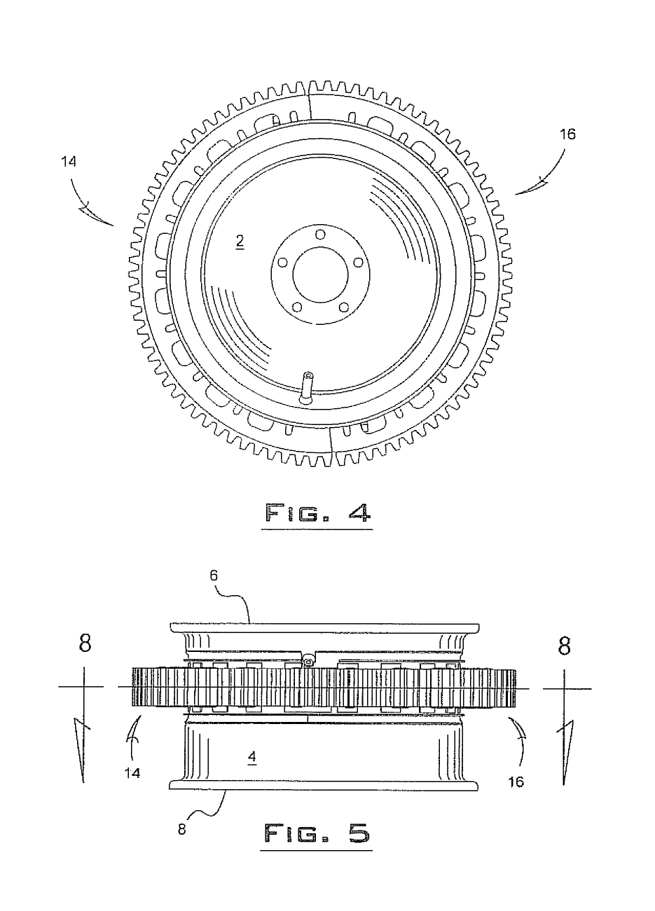

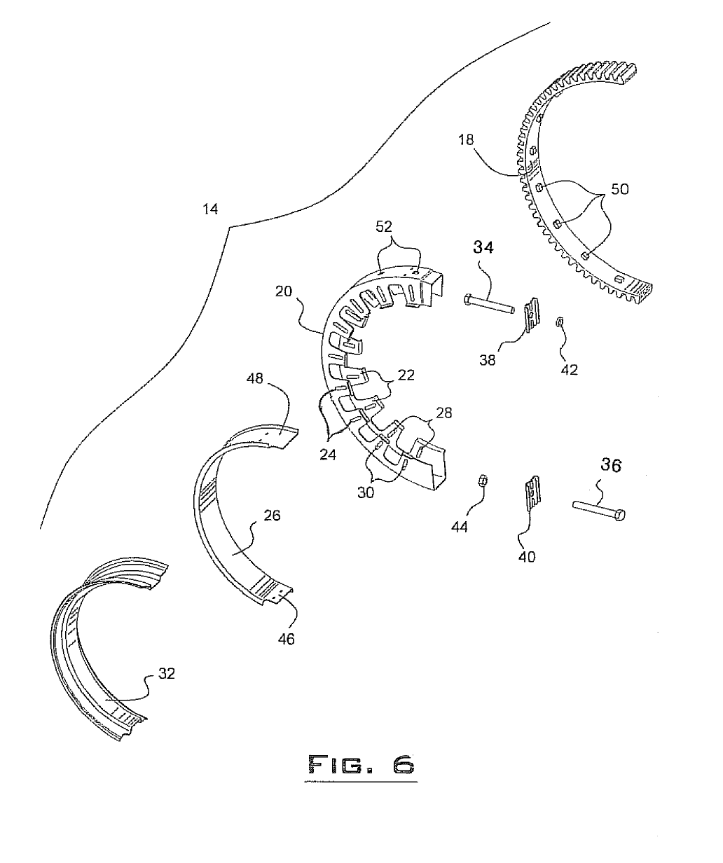

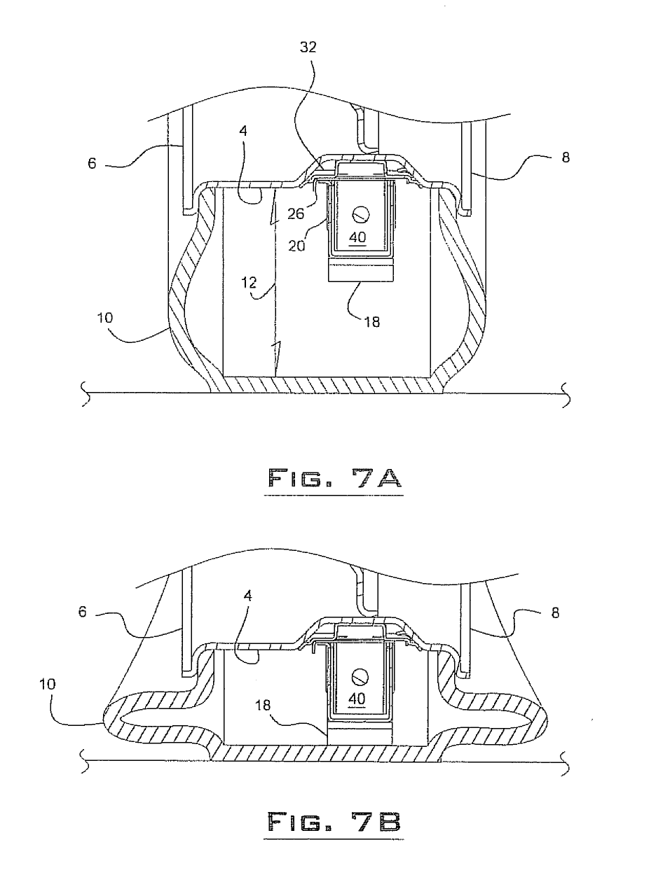

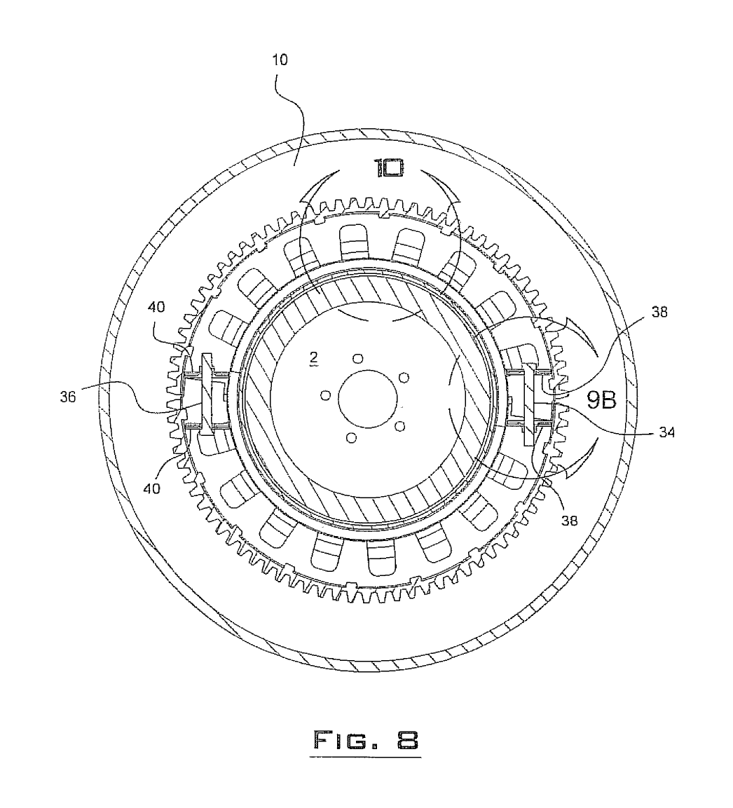

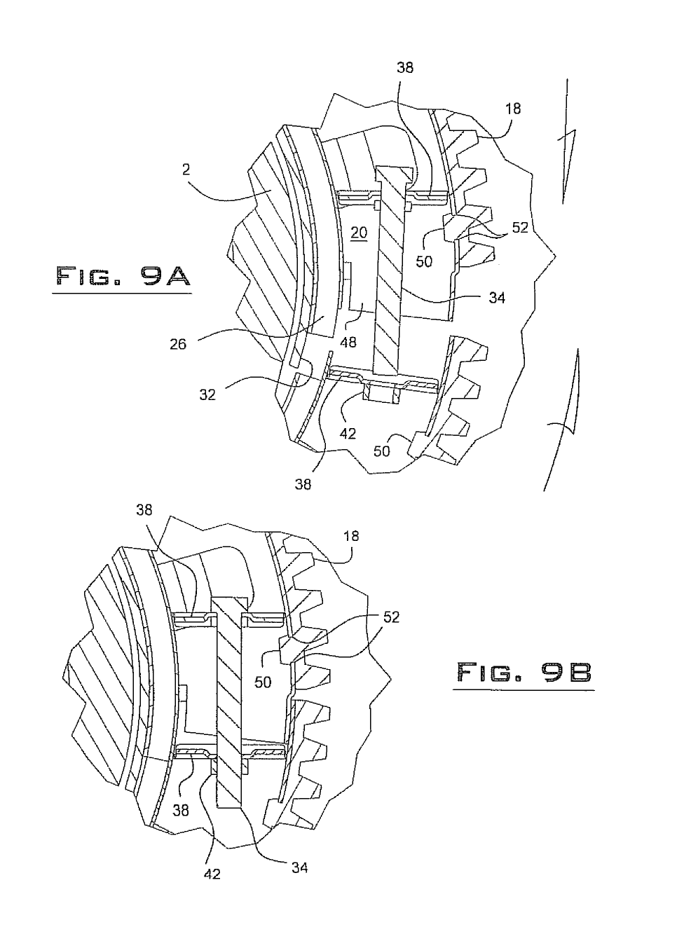

Referring initially to each of FIGS. 1-5, and as best shown in FIG. 2, a conventional vehicle wheel 2 is illustrated and exhibits in end profile a circumferential extending support surface 4 which separates inner 6 and outer 8 rim edges. The inflatable (and conventionally internally hollow doughnut shaped) tire is further depicted at 10 and is mounted and supported in sealed fashion over the wheel 2 in relation to spaced rim edges 6 and 8 such as best shown in cutaway end view in FIG. 7A and so that a distance 12 separates the wheel support surface 4 from the outer annular and road supporting layer of the tire 10.

As further illustrated throughout the several views, the run flat tire is provided as a generally identical pair of custom configured and circumferentially assembleable semi-circular body portions (or insert halves), shown generally at 14 and 16 in selected FIGS. 1, 2 and 4. FIG. 6 depicts an exploded view of selected semi-circular subassembly 14 and includes an outer rubber compound and exteriorly toothed ring 18 which is secured to a likewise shaped and underlying main body 20, generally “U” shaped in cross sectional profile and which is typically constructed of a stamped steel or aluminum material (such as further to inhibit or prevent galvanic corrosion) with stiffening beads configured into configured and spaced apart and extending side locations 22 and 24 of the body 20 in order to provide added strength.

A further semi-circular shaped body cap 26 (depicted as a flat band in end profile) is secured such as by welding or otherwise to inner support locations 28 and 30 associated with the spaced apart sides of the main body 20. An innermost layer further includes a rim mounting ring 32 and such as which is configured relative to the other components of the assembly in order to fit any custom rim profile or design of a given vehicle make and manufacture, with the ring 32 being similarly welded or toggle locked in place. The subassemblies 14 and 16 are each otherwise configured with generally identical height and width as determined by the type of vehicle and tire size.

The corresponding semi-circular shaped and inter-engageable subassembly 16 includes the same arrangement and configuration and parts and such that the two subassemblies 14 and 16 are fastener engaged in end-to-end fashion by a pair of heavy duty bolts 34 and 36 (see again FIG. 6) which extend through interior apertures defined within support plates 38 and 40 disposed between the halves 14 and 16 (and which are understood to be formed in spaced apart pairs as further depicted in FIG. 8 so as to maintain correct overlapping engagement between the semicircular sub-assemblies 14 and 16). A pair of hex nuts 42 and 44 are provided, such as each including nylon lock inserts or the like to prevent inadvertent loosening over time.

By virtue of their construction, each of the inner rim mounting rings, e.g. again at 32 in FIG. 6 for selected exploded subassembly 14, includes arcuately extending end tongues 46 and 48 which are designed to overlap a selected distance (such as without limitation ¾″) corresponding end tongues associated with the opposing and inter-engaging inn rim mounting ring associated with second subassembly 16. The overlapping tongues further provide added strength to the joints established between the assembled semicircular subassemblies 14 and 16 and can further be notched or otherwise reconfigured in order to provide clearance for any desired tire pressure monitoring devices which may be located upon the inner wheel surface 4.

The surface of the ring 32 in contact with the recessed annular wheel surface 4 may further exhibit a coating of an insulating compound to prevent slipping and possible galvanic corrosion of the ring 32. Conversely, the design of the outer rubber toothed ring 18 is such that it will allow for slippage inside the tire 10 (along with the main body 20 and cap 26 and relative to the inner ring 32 and wheel 2) when it is rolling flat (FIG. 7B).

As further depicted in FIG. 6, along with selected FIG. 10, snap-engagement of the rubber ring 18 to the exterior of the main body 20 is provided by a plurality of projecting portions 50 associated with an inner annular surface of the rubberized outer tread ring 18 in engagement with aligning recess locations defined between spaced apart notch or cutout walls, see at 52, defined in the supporting annular surface of the main arcuate body and in order to maintain the tread 18 in engagement with the main body 20.

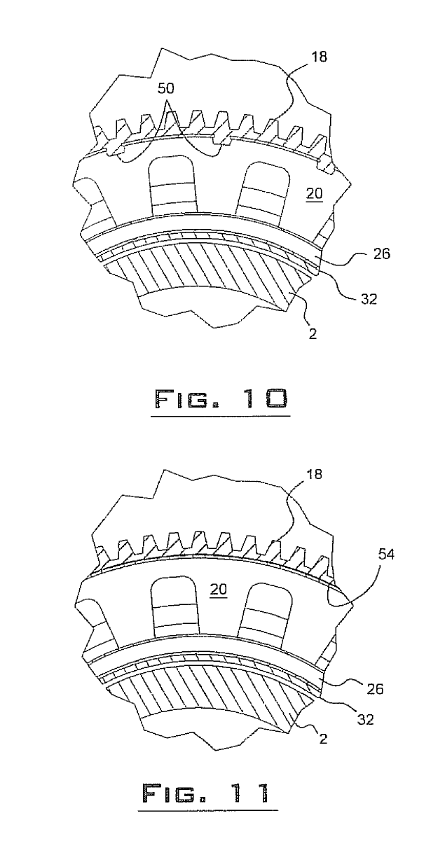

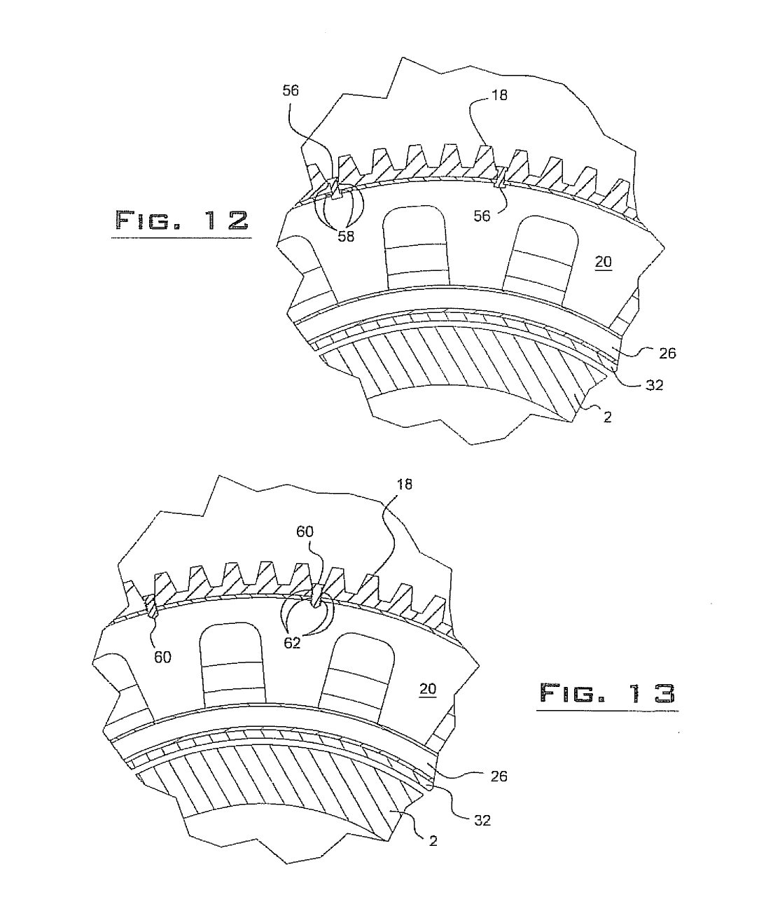

Referring to FIG. 11, an alternate attachment configuration for securing the outer rubber ring 18 to the opposing annular rim surface of the main stamped body 20 includes the use of an adhesive agent 54 secures the outer tread material to the underlying main arcuate body. FIG. 12 is a further illustration of another alternate attachment configuration depicting a series of circumferentially spaced rivets 56 for securing overlapping apertures 58 in both the outer tread material and underlying main arcuate body 20. FIG. 13 is a yet further illustration of another attachment configuration depicting a series of circumferentially spaced screws 60 for securing the outer tread material to the underlying main arcuate body via further overlapping apertures 62.

In use, the design of the roll flat tire is such that, in the event of deflation of the outer (nominal) supporting tire 10 (as shown in FIG. 7B) the exterior toothed surface of the rubber ring 18 provides inner support to the annular tread of the tire 10 and so that the vehicle can maintain control and ongoing travel indefinitely. The engineered slippage designed into the toothed ring 18 additionally compensates for any differences in diameter between the tire and insert (e.g. such as 3″ top to bottom).

Having described my invention, other and additional preferred embodiments will become apparent to those skilled in the art to which it pertains, and without deviating from the scope of the appended claims.

1. A run flat tire for use with a conventional wheel supporting an outer tire, comprising:
first and second semi-circular shaped subassemblies adapted to being inter-engaged in end-to-end fashion around an annular surface of the wheel; and
each of said subassemblies exhibiting an outer support ring adapted to engage a deflated inner surface of the outer tire in a run flat condition.

2. The run flat tire in claim 1, said first and second subassemblies each further comprising a stamped metal body exhibiting a substantially “U” shape in cross section and including stiffening beads for increased strength.

3. The run flat tire in claim 2, each of said first and second subassemblies further comprising a semi-circular shaped body cap exhibiting a flat band in end profile and secured to inner support locations associated with spaced apart sides of said main body.

4. The run flat tire in claim 3, each of said first and second subassemblies further comprising an innermost rim mounting ring welded or toggle locked in place in secure fashion to the annular wheel surface.

5. The run flat tire in claim 4, said innermost rim mounting ring further comprising a customizable cross sectional profile for matching a selected wheel rim design associated with a given vehicle make or manufacture.

6. The run flat tire in claim 2, each of said stamped metal bodies further comprising an anti-galvanic material.

7. A run flat tire for use with a conventional wheel supporting an outer tire, comprising:
first and second semi-circular shaped subassemblies adapted to being inter-engaged in end-to-end fashion around an annular surface of the wheel;
each of said first and second subassemblies further including a stamped metal body exhibiting a substantially “U” shape in cross section and including stiffening beads for increased strength; and
an exteriorly toothed ring constructed of a rubberized material affixing around each of said stamped metal bodies adapted to engage a deflated inner surface of the outer tire in a run flat condition while allowing for slippage between said inter-engaged subassemblies and the wheel.

8. The run flat tire of claim 7, further comprising a pair of heavy duty bolts which extend through aligning apertures defined within individual pairs of support plates mounted to opposing ends of said semi-circular subassemblies, a pair of nuts engaging said bolts.

9. The run flat tire of claim 7, further comprising a plurality of circumferentially spaced projecting portions associated with inner annular surfaces of said rubberized ring which engage through recess locations defined in a supporting annular surface of said stamped metal body.

10. The run flat tire of claim 7, further comprising a plurality of circumferentially spaced rivets securing inner annular surfaces of said rubberized ring to aligning recesses defined in a supporting annular surface of said stamped metal body.

11. The run flat tire in claim 7, each of said first and second subassemblies further comprising a semi-circular shaped body cap exhibiting a flat band in end profile and secured to inner support locations associated with spaced apart sides of said body.

12. The run flat tire in claim 11, each of said first and second subassemblies further comprising an innermost rim mounting ring welded or toggle locked in place in secure fashion to the annular wheel surface.

13. The run flat tire in claim 12, said innermost rim mounting ring further comprising a customizable cross sectional profile for matching a selected wheel rim design associated with a given vehicle make or manufacture.

14. The run flat tire in claim 7, each of said stamped metal bodies further comprising an anti-galvanic material.

15. A run flat tire for use with a conventional wheel supporting an outer tire, comprising:
first and second semi-circular shaped subassemblies adapted to being inter-engaged in end-to-end fashion around an annular surface of the wheel;
each of said first and second subassemblies further including:
a stamped metal body exhibiting a substantially “U” shape in cross section and including stiffening beads for increased strength;
an exteriorly toothed ring constructed of a rubberized material affixing around each of said stamped metal bodies;
a semi-circular shaped body cap exhibiting a flat band in end profile and secured to inner support locations associated with spaced apart sides of said body; and
an innermost rim mounting ring welded or toggle locked in place in secure fashion to the annular wheel surface
said body and outer toothed ring adapted to engage a deflated inner surface of the outer tire in a run flat condition while allowing for slippage relative the wheel.

16. The run flat tire of claim 15, further comprising a pair of heavy duty bolts which extend through aligning apertures defined within individual pairs of support plates mounted to opposing ends of said semi-circular subassemblies, a pair of nuts engaging said bolts.

17. The run flat tire of claim 15, further comprising a plurality of circumferentially spaced projecting portions associated with inner annular surfaces of said rubberized ring which engage through recess locations defined in a supporting annular surface of said stamped metal body.

18. The run flat tire of claim 15, further comprising a plurality of circumferentially spaced rivets securing inner annular surfaces of said rubberized ring to aligning recesses defined in a supporting annular surface of said stamped metal body.

19. The run flat tire in claim 15, said innermost rim mounting ring further comprising a customizable cross sectional profile for matching a selected wheel rim design associated with a given vehicle make or manufacture.

20. The run flat tire in claim 15, each of said stamped metal bodies further comprising an anti-galvanic material.
